(19) United States
(12) Patent Application Publication
(10) Pub. No.: US 2016/0226299 A1
(43) Pub. Date: Aug. 4, 2016

(54) WIRELESS POWER TRANSMITTER AND WIRELESS POWER RECEIVER

(71) Applicant: Samsung Electro-Mechanics Co., Ltd., Suwon-si (KR)

(72) Inventors: Isaac NAM, Suwon-si (KR); Soon Tack OH, Suwon-si (KR); Si Hyung KIM, Suwon-si (KR); Jae Suk SUNG, Suwon-si (KR); Ki Won CHANG, Suwon-si (KR); Chul Gyun PARK, Suwon-si (KR); Chang Soo KANG, Suwon-si (KR); Ji Hoon KIM, Suwon-si (KR)

(73) Assignee: Samsung Electro-Mechanics Co., Ltd., Suwon-si (KR)

(21) Appl. No.: 15/009,075

(22) Filed: Jan. 28, 2016

(30) Foreign Application Priority Data
Jan. 30, 2015 (KR) 10-2015-0015237
Dec. 3, 2015 (KR) 10-2015-0171531

(51) Int. Cl. H02J 7/04; H02J 7/02; H02J 50/10; H02J 50/80; H02J 50/30

(52) U.S. Cl. CPC H02J 7/042; H02J 50/80; H02J 50/30; H02J 50/10; H02J 7/025

(57) ABSTRACT

A wireless power transmitter includes a controller configured to output a control signal in response to detected light, and a power transmitting circuit which is configured to wirelessly radiate power in response to the control signal.

### CROSS-REFERENCE TO RELATED APPLICATION(S)

This application claims the benefit of Korean Patent Application No. 10-2015-0015237 filed on Jan. 30, 2015 and 10-2015-0171531 filed on Dec. 3, 2015, in the Korean Intellectual Property Office, the entire disclosures of which are incorporated herein by reference for all purposes.

### BACKGROUND

1. Field

The present disclosure relates to a wireless power transmitter and a wireless power receiver.

2. Description of Related Art

Wireless power transmitting technology has been gradually utilized in various fields such as that of small devices, for example, hearing aids, and the like, as well as in various mobile devices, for example, smartphones, or the like.

When a wireless power transmitter wirelessly transmits power to a wireless power receiver, the wireless power transmitter receives information related to a state of the wireless power receiver, for example, a state of battery charge of the wireless power receiver, or the like, and needs to adjust a magnitude of wireless power transmitted thereby depending on the information. To this end, the wireless power receiver and the wireless power transmitter may be provided with communications units for transmitting the above-mentioned information, respectively.

However, in a case in which a size of the wireless power receiver such as the hearing aid is reduced, it is significantly difficult to add a communications unit according to the related art to the wireless power receiver.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, a wireless power transmitter includes a controller configured to output a control signal in response to detected light; and a power transmitting circuit which is configured to wirelessly radiate power in response to the control signal.

The wireless power transmitter may further include a case providing an internal space accommodating the wireless power receiver therein and having the controller and the power transmitting circuit mounted thereon.

The power transmitting circuit may be configured to wirelessly supply the power when the case is closed and blocks supply of the power when the case is open.

The wireless power transmitter may further include an opening and closing detector including at least one terminal opened or short-circuited depending on whether the case is respectively open or closed.

The controller may be configured to output the control signal depending on states of the at least one terminal of the opening and closing detector.

The wireless power transmitter may further include a sensor configured to output a sensing signal depending on whether the case is open or closed.

The controller may be configured to output the control signal in response to detected light, the sensing signal, or combinations thereof.

The controller may include a detector configured to output a detection signal depending on an intensity of received light; and a control signal generator configured to output the control signal in response to the detection signal.

The detector may include a first voltage generator configured to receive power and to responsively output a first voltage; a second voltage generator configured to receive the power and to responsively output a second voltage varied depending on the intensity of received light; and a comparator circuit configured to compare the first voltage and the second voltage with each other and responsive to the comparison, to output the detection signal.

The second voltage generator may include a resistor connected to a terminal to which the power is input; and a light detecting resistor (LDR) connected between the resistor and a ground and configured to establish a resistance value varied depending on the intensity of received light.

The resistor may be a variable resistor configured to have a resistance value varied in response to an adjustment signal input from an external source.

The wireless power transmitter may further include a power supply configured to supply the power to the controller and the power transmitting circuit.

According to another general aspect, a wireless power receiver apparatus includes a power receiver configured to receive wirelessly transmitted power and output charging power for charging a battery; a power managing circuit configured to control the power receiver depending on a level of charge of the battery; and an indicator configured to irradiate light depending on a determined status of the battery.

The power receiver may include a receiver configured to receive the wirelessly transmitted power using a receiving coil; and a converter configured to convert the power received by the receiver into the charging power in response to a control signal output by the power managing circuit.

The indicator may include a light emitting diode connected between the battery and the converting unit.

According to another general aspect, a wireless power transmission method includes actuating a power supply to radiate a wireless power from a resonator; continuously determining a luminance characteristic; and adaptively controlling the power supply to change the wireless power radiation responsive to detected changes in the luminance characteristic.

The power supply may be actuated responsive to a determination that a wireless power receiving apparatus has been enclosed within a wireless power transmission apparatus.

The power supply may be actuated responsive to a determination that a locking mechanism has been actuated to lock a wireless receiving apparatus within a wireless transmission apparatus.

The power supply may be adaptively controlled to change a magnitude of the wireless power transmission according to a determined luminance characteristic of a wireless power receiving apparatus.

According to another general aspect, a method of controlling wireless power charging includes determining an operational characteristic in a wireless power receiver; selectively actuating a light emitting device within the wireless power receiver to emit a light indicating a requested magnitude of wireless power radiation according to the determined operational characteristic; and, responsive to reception of a wireless power radiation, actuating a power management circuit to supply current to a battery within the wireless power receiver.

The light emitting device may be selectively actuated to emit a light pattern encoding a requested magnitude of wireless power radiation from a wireless power transmitter according to the determined operational characteristic in the wireless power receiver.

The operational characteristic may include at least one of: voltage across the battery, current flow, temperature, or time, or combinations thereof.

The light emitting device may be selectively actuated at a luminance intensity corresponding to a requested magnitude of wireless power radiation from the wireless power transmitter according to the determined operational characteristic in the wireless power receiver.

Other features and aspects will be apparent from the following detailed description, the drawings, and the claims.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a view schematically illustrating an application of a wireless power transmitter according to an exemplary embodiment.

FIG. 2 is a view schematically illustrating a device including a wireless power receiver according to an exemplary embodiment.

FIG. 3 is a view illustrating an example of a light detecting resistor (LDR) of the wireless power transmitter according to an exemplary embodiment illustrated in FIG.

FIGS. 4 and 5 are views illustrating characteristics of an example of the LDR illustrated in FIG. 3.

FIG. 6 is a block diagram schematically illustrating a wireless power transmitting system including the wireless power transmitter and the wireless power receiver according to an exemplary embodiment.

FIG. 7 is a block diagram schematically illustrating a wireless power transmitter according to an exemplary embodiment.

FIG. 8 is a view schematically illustrating a configuration of an example of a detector of a controller of the wireless power transmitter according to an exemplary embodiment illustrated in FIG. 7.

FIG. 9 is a view schematically illustrating a configuration of an example of a power transmitting circuit of the wireless power transmitter according to an exemplary embodiment illustrated in FIG. 7.

FIG. 10 is a view schematically illustrating the wireless power transmitting system including the wireless power transmitter and the wireless power receiver according to an exemplary embodiment.

FIG. 11 is a flow chart illustrating a wireless power transmitting method according to an exemplary embodiment.

FIG. 12 is a view schematically illustrating an application of the wireless power transmitter according to an exemplary embodiment.

FIG. 13 is a view schematically illustrating an example of a detector of a controller that may be used in the application of the wireless power transmitter according to an exemplary embodiment illustrated in FIG. 12.

FIG. 14 is a view schematically illustrating an example of a device including the wireless power receiver according to an exemplary embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “upper” or “above” other elements would then be oriented “below,” or “lower” than the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein is for describing particular exemplary embodiments only and is not intended to be limiting. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments of the present inventive concept will be described with reference to schematic views illustrating embodiments of the present inventive concept. In the drawings, for example, due to manufacturing techniques and/or tolerances, modifications of the shape shown may be estimated. Thus, the exemplary embodiments should not be construed as being limited to the particular shapes of regions shown herein, but should, for example, be interpreted to include a change in shape resulting from manufacturing. The following embodiments may also be combined, interposed, or separated.

The contents of the present description below may have a variety of configurations and propose only a few exemplary configurations herein, but are not limited thereto.

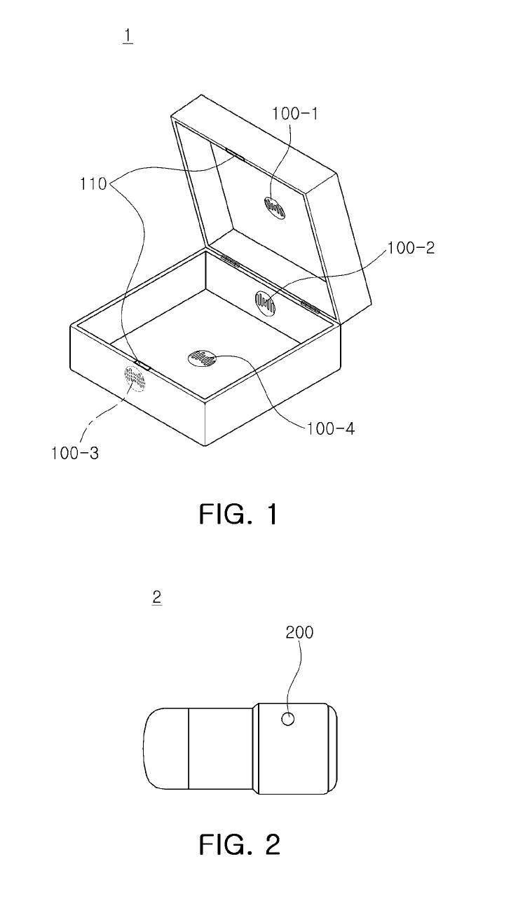

FIG. 1 is a view schematically illustrating an application of a wireless power transmitter according to an exemplary embodiment. Reference numerals 100-1, 100-2, 100-3, and 100-4 of FIG. 1 indicate light sensors such as light detecting resistors (LDRs) shown in the instant example, photodiodes, or other suitable light responsive elements, and reference numeral 110 of FIG. 1 indicates an opening and closing detector. While opening and closing detector 110 is shown on both lateral sides of a closing member, the detector 110 may be disposed on a single side. For example, opening and closing detector 110 may include a hall sensor disposed on one side and a magnet disposed on another side such that when the magnet is brought proximate the hall sensor, an opening or closing may be detected. The opening and closing detector 110 may include a mechanically displaceable sensor on one side of the closing case which is displaced when the opposing side of the case is brought into a closed position. Other suitable detection configurations may be employed as well.

A case 1 may have an internal space in which a wireless power receiver apparatus may be disposed. In the event in which the case 1 is closed, the introduction of light from the outside into the internal space may be blocked. The case 1 may have a size allowing for portability.

The LDRs 100-1, 100-2, 100-3, and 100-4 may have resistance varied depending on the intensity of light incident thereto, and may be disposed in the case 1. Although a case in which four LDRs are provided has been illustrated in FIG. 1, the number of LDRs and positions of the LDRs may be variously modified. Any element which has electrical characteristics varied depending on the intensity of light incident thereto may be used instead of the LDRs.

The opening and closing detector 110 may be implemented in a form similar to a switch. That is, when the case 1 is closed, two terminals of the opening and closing detector 110 may be short-circuited, and when the case 1 is open, the two terminals of the opening and closing detector 110 may be opened.

Although not illustrated in FIG. 1, the opening and closing detector 110 may also be implemented using various types of sensors sensing whether the case 1 is open or closed to output sensing signals. For example, the sensors may also output the sensing signals depending on states of the two terminals of the opening and closing detector 110 of FIG. 1. Alternatively, the case 1 may further include a locking apparatus for fixing a state in which the case 1 is closed, and in this case, the sensors may output the sensing signals depending on a state of the locking apparatus.

Although not illustrated in FIG. 1, the case 1 may have a controller outputting a control signal in response to light and a power transmitting circuit configured to wirelessly transmit power in response to the control signal mounted thereon. In this case, the controller may output the control signal depending on electrical characteristics of the LDRs 100-1, 100-2, 100-3, and 100-4.

Although a case in which the LDRs are used has been illustrated in FIG. 1, the wireless power transmitter according to an exemplary embodiment may be implemented using various elements of which characteristics are varied depending on incident light.

FIG. 2, a view schematically illustrating a device 2 including a wireless power receiver according to an exemplary embodiment, illustrates a case in which the wireless power receiver according to an exemplary embodiment in the present disclosure is applied to a small hearing aid.

The device including the wireless power receiver according to an exemplary embodiment may include a battery (not illustrated) and an indicator 200 indicating information related to a state of the battery using light. The information related to the state of the battery may include information related to whether or not the battery is charged, information related to a current level of charge of the battery, temperature, battery voltage, time spent charging, and the like. The indicator 200 may be implemented using one or several light emitting diodes, or the like. Where there are several light emitting diodes, they may be arranged on a number of transverse faces of the device.

Charging the battery (not illustrated) of the device illustrated in FIG. 2 may be performed within the case 1 in which the wireless power transmitter is mounted, similar to an example illustrated in FIG. 1. When the case is closed, external light may also be blocked from being introduced into the case.

According to an exemplary embodiment in the present disclosure, the wireless power transmitter may control a magnitude of wirelessly transmitted power and/or whether or not power is wirelessly transmitted depending on the level of charge of the battery, current flow, a temperature, a voltage, level, change rate, or the like of the wireless power receiver. Particularly, in a case in which wireless charging of the small device as illustrated in FIG. 2 is performed in an internal space of the case illustrated in FIG. 1, the magnitude of wirelessly transmitted power and/or whether or not the power is wirelessly transmitted may be more accurately controlled.

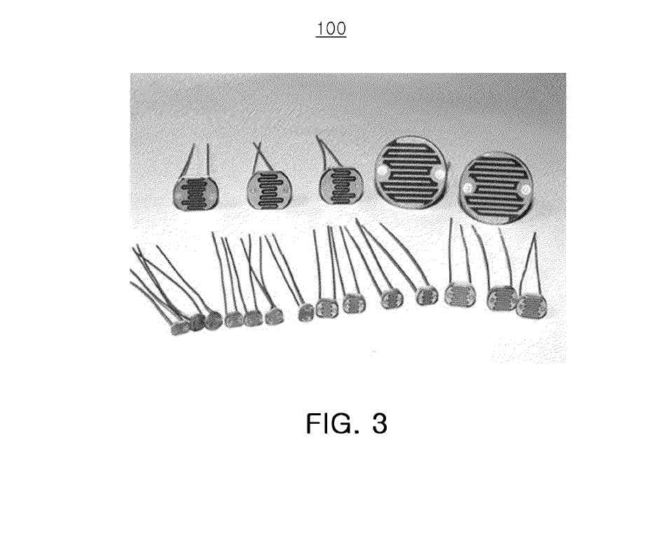

FIG. 3 is a view schematically illustrating an example of an LDR of the wireless power transmitter according to an exemplary embodiment illustrated in FIG. 1.

The LDR 100 may be implemented in a form of a substrate having various patterns formed on a surface thereof.

Each of the LDRs 100-1, 100-2, 100-3, and 100-4 of FIG. 1 may have the same configuration as that of the LDR 100 illustrated in FIG. 3.

However, the LDRs 100-1, 100-2, 100-3, and 100-4 of FIG. 1 are not limited to the LDR of FIG. 3. As described above, the LDRs 100-1, 100-2, 100-3, and 100-4 of FIG. 1 may be implemented using various elements of which characteristics are varied depending on the light incident thereto. For example, the LDRs 100-1, 100-2, 100-3, and 100-4 of FIG. 1 may also be implemented using photoelectric elements of which output voltages are varied depending on an illuminance of light incident thereto.

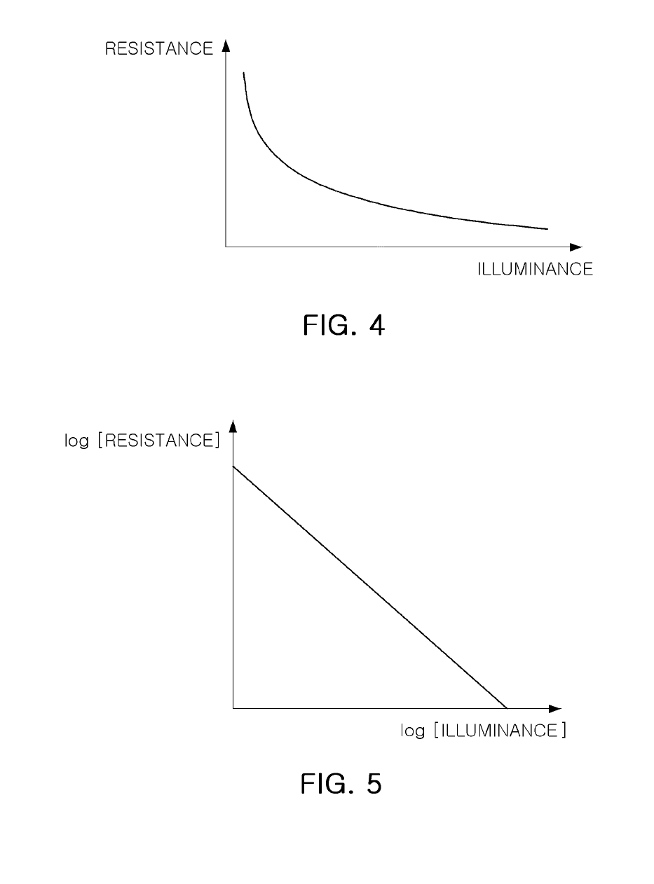

FIGS. 4 and 5 are views illustrating exemplary characteristics of one example of the LDR illustrated in FIG. 3, wherein FIG. 4 illustrates a correlation between an illuminance of incident light and a resistance of the LDR, and FIG. 5 illustrates the correlation between the illuminance of incident light and the resistance of the LDR in a logarithmic or log scale.

In this case, as illustrated in FIGS. 4 and 5, when a light intensity incident to the light detecting resistor is decreased, a resistance value of the light detecting resistor may become large, when the light intensity incident to the light detecting resistor becomes large, a resistance value of the light detecting resistor may become small.

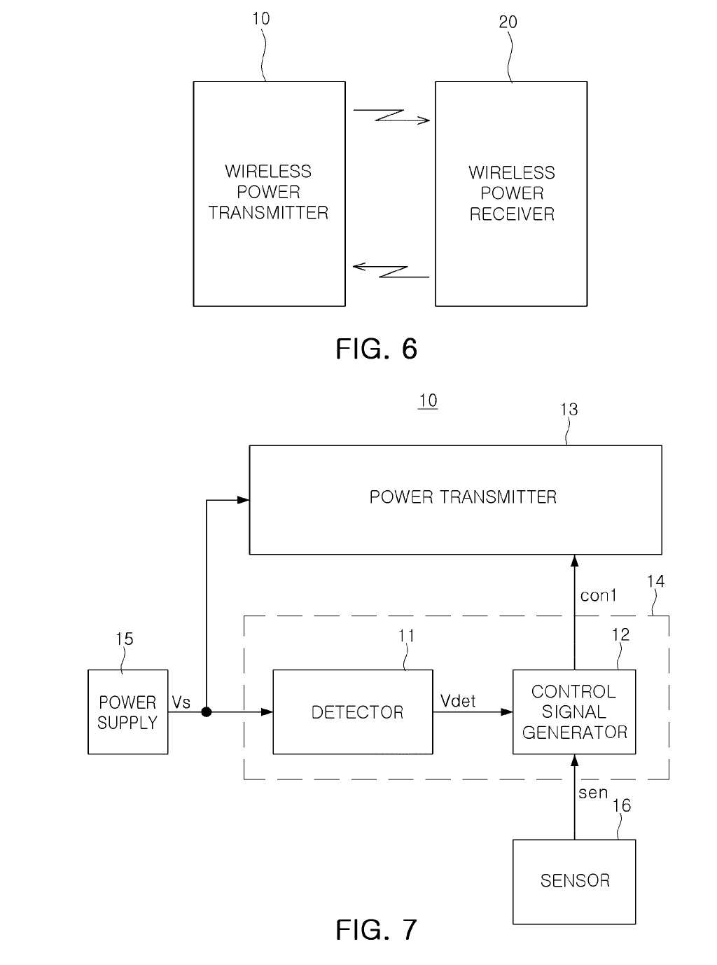

FIG. 6 is a block diagram schematically illustrating a wireless power transmitting system including the wireless power transmitter 10 and the wireless power receiver 20 according to an exemplary embodiment.

The wireless power transmitter 10 may wirelessly supply the power to the wireless power receiver 20. Here, a magnitude of the power supplied from the wireless power transmitter 10 or whether or not the power is supplied may be controlled depending on light generated in the wireless power receiver 20.

The wireless power receiver 20 may wirelessly receive the power supplied from the wireless power transmitter 10. The wireless power receiver 20 may include a battery (not illustrated), and may charge the battery using the power supplied from the wireless power transmitter 10. In addition, the wireless power receiver 20 may indicate information related to a state of the battery using light. The information related to the state of the battery may include information related to whether or not charging for the battery is being performed, information related to a level of charge of the battery, a battery temperature, current flow, voltage level, change in voltage over time, and the like.

FIG. 7 is a block diagram schematically illustrating the wireless power transmitter according to an exemplary embodiment in the present disclosure. The wireless power transmitter 10 according to an exemplary embodiment in the present disclosure may include a power transmitting circuit 13, a controller 14, and a power supply 15. The controller 14 may include a detector 11 and a control signal generator 12. In addition, the wireless power transmitter 10 may further include a sensor 16.

The power transmitting circuit 13 may wirelessly transmit power in response to a first control signal con1. The power transmitting circuit 13 may apply alternating current (AC) power to at least one transmitting coil (not illustrated) using power Vs supplied from the power supply 15, thereby wirelessly transmitting the power. Here, a magnitude of the AC power applied to the transmitting coil (not illustrated), whether or not the AC power is applied to the transmitting coil (not illustrated), and the like, may be determined depending on the first control signal con1.

The controller 14 may output the first control signal con1 depending on incident light detected by detector 11 which may include at least one light sensitive component, such as an LDR. As described above, the wireless power receiver wirelessly receiving the power may provide the information related to the battery using the light. That is, the controller 14 may output the first control signal con1 depending on the light output by the wireless power receiver 2. Controller 14 may monitor for light of a specific intensity, wavelength, frequency, polarization, modulation, encoding, of the light for modulation or representation of data, battery condition, or the like.

The detector 11 may output a detection signal Vdet depending upon the detection of the incident light. The detector 11 may output a detection signal Vdet having a first state in a case in which an intensity of incident light is equal to a reference value or more, and output a detection signal Vdet having a second state in a case in which an intensity of incident light is less than the reference value. Alternatively, the detector 11 may vary a voltage of the detection signal Vdet depending on the intensity of incident light and then output the detection signal of which the voltage is varied. Alternatively, the detector 11 may vary a state or a voltage of the detection signal Vdet depending on the number of incident lights, positions in which the lights are generated, wavelength, polarization, strobe, or the like, and then output the detection signal of which the state or the voltage is varied.

The control signal generator 12 may output the first control signal con1 in response to the detection signal Vdet. For example, the control signal generator 12 may adjust a pulse width or a frequency of the first control signal con1 or output the first control signal con1 in one of a form of a pulse signal and a form of a low-level signal, in response to the detection signal Vdet. In detail, the control signal generator 12 may be configured to include a specially programmed microprocessor, or the like, and may vary the first control signal con1 depending on the detection signal Vdet. Alternatively, the control signal generator 12 may include an oscillator generating a pulse signal and a gate circuit outputting the pulse signal or a low-level signal as the first control signal con1 in response to the detection signal Vdet.

The power supply 15 may supply power Vs to the power transmitting circuit 13 and/or the controller 14.

As described with reference to FIG. 1, the wireless power transmitter according to the present disclosure may be applied to the case 1 blocking the light introduced from the outside thereinto when the case 1 in which the wireless power receiver 2 is accommodated is closed. In this case, as illustrated in FIG. 1, the opening and closing detector 110 (see FIG. 1) may be included in the case 1 (see FIG. 1), and the controller 14 may output the first control signal con1 depending on a state of the opening and closing detector 110 (see FIG. 1) to control an operation of the power transmitting circuit 13 depending on whether the case 1 (see FIG. 1) is open or closed. Where detector 11 is keyed to a specific frequency, wavelength, or polarization of light emitted by led 200 in the power receiver 2, the opening and closing detector 110 may be omitted.

Where the opening and closing detector 110 is included, the wireless power transmitter 10 according to the present disclosure may further include the sensor 16. The sensor 16 may sense states of the two terminals of the opening and closing detector 110 to output a sensing signal sen. The control signal generator 12 may output the first control signal con1 in response to the sensing signal sen. As another example, when the sensing signal sen indicates a state in which the case 1 (see FIG. 1) is open is sent to the control signal generator 12, the control signal generator 12 may maintain the first control signal con1 in a high-level state or a low-level state to allow the power not to be transmitted. As described with reference to FIG. 1, the case 1 (see FIG. 1) may further include the locking apparatus for maintaining the state in which the case 1 is closed. In this case, the sensor 16 may sense a state of the locking apparatus to output the sensing signal sen.

Although not illustrated, the power Vs may be selectively supplied or blocked from the power supply 15 by the opening and closing detector 110 of FIG. 1. Alternatively, the controller 14 may directly detect a state of the opening and closing detector 110 of FIG. 1, and output the first control signal con1 depending on a detected result. In this case, the sensor 16 may also be omitted.

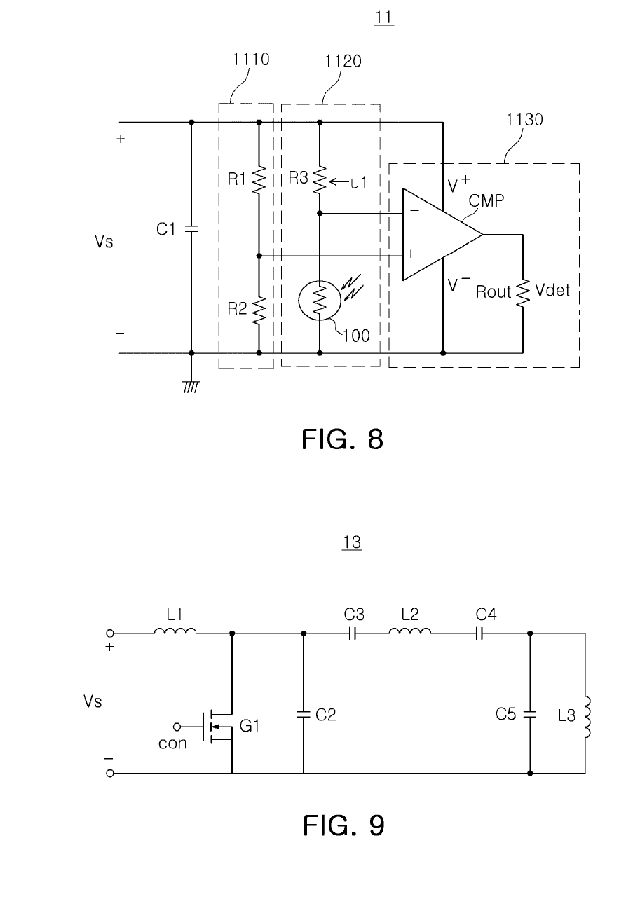

FIG. 8 is a view schematically illustrating a configuration of an example of a detector 11 of a controller 14 of the wireless power transmitter 10 according to an exemplary embodiment illustrated in FIG. 7. The detector 11 includes a first voltage generator 1110, a second voltage generator 1120, and a comparator circuit 1130. The first voltage generator 1110 includes a first resistor R1 and a second resistor R2 connected to each other in series between a terminal to which the power Vs is input and a ground. The second voltage generator 1120 includes a third resistor R3 and the LDR 100 connected to each other in series between the terminal to which the power Vs is input and the ground. The comparator circuit 1130 includes a comparator CMP and an output resistor Rout connected between an output node of the comparator CMP and the ground. The detector 11 further includes a first capacitor Cl connected between the terminal to which the power Vs is input and the ground.

The first voltage generator 1110 receives the power Vs and outputs a first voltage. The first voltage has a magnitude that is not associated with an intensity of incident light. In detail, the first resistor R1 and the second resistor R2 serve as a voltage divider, and divide a voltage of the power Vs to output the first voltage. The first voltage is input to a first terminal (for example, a positive (+) terminal) of the comparator CMP.

The second voltage generator 1120 receives the power Vs and outputs a second voltage varied depending on, for example, an intensity of incident light. In detail, the third resistor R3 and the LDR 100 serve as a voltage divider, and a magnitude of the second voltage may be varied depending on a resistance value of the LDR 100. The second voltage is input to a second terminal (for example, a negative (-) terminal) of the comparator CMP.

The comparator circuit 1130 compares the first voltage and the second voltage with each other to output a detection signal Vdet.

When a light intensity incident to the LDR 100 is lower than a reference value, a resistance value of the LDR 100 will be high, such that the second voltage will be higher than the first voltage. Therefore, the comparator circuit 1130 outputs a low-level detection signal Vdet.

On the other hand, when the light intensity incident to the LDR 100 is higher than the reference value, the resistance value of the LDR 100 will be low, such that the second voltage will be lower than the first voltage. Therefore, the comparator circuit 1130 will responsively output a high-level detection signal Vdet.

A resistance value of the third resistor R3 may be adjusted. That is, the third resistor R3 may be a variable resistor. The resistance value of the third resistor R3 may be adjusted to adjust the reference value. To this end, the detector 11 may receive a first adjustment signal u1.

Although an example in which the detection signal Vdet indicating whether the light intensity incident to the LDR is the reference value, or more or is less than the reference value, is output using the comparator has been illustrated in FIG. 8, the second voltage may also be output as the detection signal Vdet as it is. In such an example, and depending upon the specific light sensitive photoelectric component employed, the voltage level Vdet may be directly correlated or inversely correlated with the amount of light incident thereon. For example, where an LDR is employed, the larger the light intensity incident to the LDR, the lower the voltage level of the detection signal Vdet.

In addition, the detector 11 may include an amplifier amplifying the second voltage or a difference between the first voltage and the second voltage instead of the comparator CMP, and output the detection signal Vdet having a magnitude varied depending on a light intensity.

As described above, a photoelectric element may be used as the LDR. In this case, the third resistor R3 may be omitted.

FIG. 9 is a view schematically illustrating a configuration of an example of a power transmitting circuit 13 of the wireless power transmitter 10 according to an exemplary embodiment illustrated in FIG. 7. The power transmitting circuit 13 includes a first coil L1 connected to a node to which the power Vs is applied, a first switch element G1 connected between the first coil L1 and a ground and switched on or off in response to the first control signal con1, a second capacitor C2 connected to the first switch element G1 in parallel. This second capacitor C2 can represent an externally implemented capacitor or the parasitic capacitor of the switch itself such as a MOSFET's output capacitor or the summation of these capacitors. A third capacitor C3 and a second coil L2 form a band-pass filter. An exemplary impedance matching network is the L-matching network consisting of a fourth capacitor C4 and a fifth capacitor C5. This impedance matching network is connected between the band-pass filter and a power transmitting coil L3. In the exemplary configuration of FIG. 9, the fifth capacitor C5 is connected in parallel with the power transmitting coil L3. One of more of the elements mentioned can be eliminated depending on reference impedances of a impedance matching network. For example, the series-connected capacitors C3 and C4 can be combined to represent the equivalent capacitance of C3*C4/(C3+C4), and a part of inductance of L3 can provide enough inductance needed for L2 so that L2 can be eliminated. Although FIG. 9 shows an example of power transmitting circuits using an example configuration of a single-ended Class E amplifier, a power transmitting circuit can be based on other inverter or amplifier topologies such as a single-ended current mode Class D amplifier or a full-bridge inverter.

The wireless power transmitting circuit 13 may input the power from the DC supply that has voltage level Vs, and converts DC voltage and current signals to AC voltage and current signals in order to apply the AC power to the power transmitting coil L3, thereby wirelessly transmitting the power. The AC power applied to the power transmitting coil L3 may be controlled by the first control signal con1.

The first coil L1 may serve as a choke inductor to maintain that the current through it has only small ripples and therefore is close to being DC current. The second capacitor C2 may be in resonance with or may be approximately in resonance with the band-pass filter, L-matching network, and power transmitting coil. Such resonance condition or close in resonance condition amplifies voltage or current so as to generate either the AC voltage whose amplitude is greater than the DC supply voltage Vs or the AC current whose amplitude is greater than the DC supply current. The amplification level may be controlled by the first control signal con1. A magnitude of the voltage output by the first coil L1, the first switching element G1, and the second capacitor C2 may be selectively set according to a duty ratio and/or frequency of the first control signal con1. In addition, a magnitude of AC power applied to the power transmitting coil L3 may be selectively established according to the magnitude of supply voltage Vs, and a magnitude of the wirelessly transmitted power may be established according to the magnitude of the AC power applied to the power transmitting coil L3.

The wireless power transmitting circuit 13 may be configured in various forms, in addition to the exemplary form illustrated in FIG. 9.

In FIG. 9, the capacitor C3, the inductor L2, the capacitor C4, and the capacitor C5 adaptively perform an impedance matching function. Alternatively, the capacitor C4 and/or the capacitor C5 may form a resonant tank together with the power transmitting coil L3.

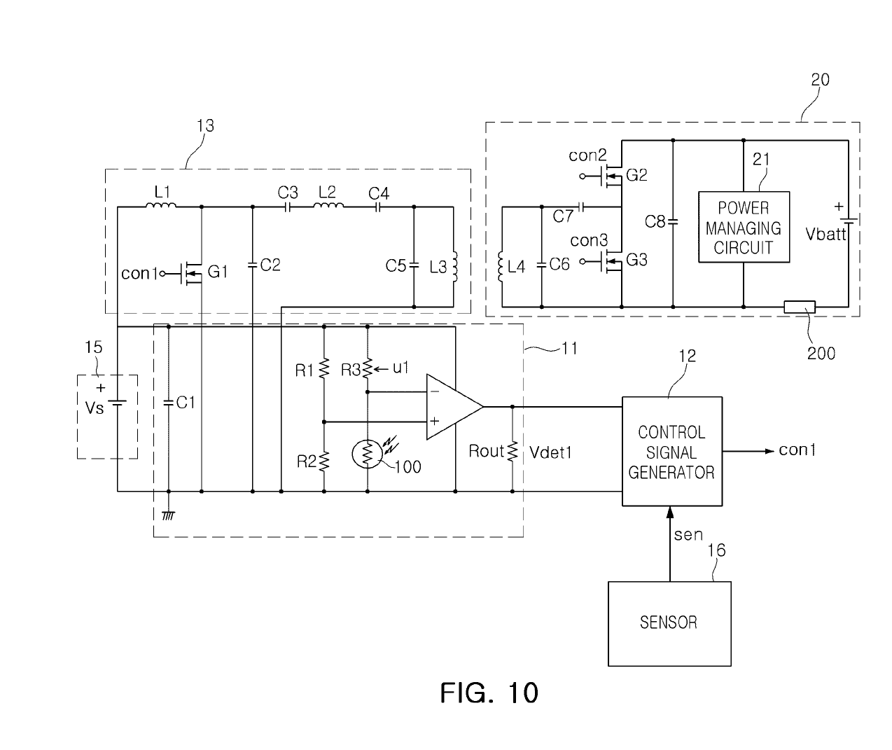

FIG. 10 is a view schematically illustrating a wireless power transmitting system including the wireless power transmitter and the wireless power receiver according to an exemplary embodiment. The wireless power transmitting system includes the wireless power transmitter including a power transmitting circuit 13, controllers 11 and 12, and a power supply 15, and the wireless power receiver 20 includes an indicator 200.

Functions and operations of the power transmitting circuit 13, the controllers 11 and 12, and the power supply 15 may be the same as or similar to the power transmitting circuit, the controller, and the power supply described with reference to FIGS. 7 through 9. Accordingly, a detailed description will be omitted in favor of clarity and conciseness.

The wireless power receiver 20 may receive the wireless power to charge a battery, and irradiate light depending on a state of the battery (for example, a level of charge of the battery).

The wireless power receiver 20 includes a power receiving coil L4 receiving the wireless power, a sixth capacitor C6 connected to the power receiving coil L4 in parallel, a seventh capacitor C7 connected to the power receiving coil L4, a third switch element G3 connected between the seventh capacitor C7 and a ground and switched on or off in response to a third control signal con1, a second switch element G2 having one end connected to the third switch element G3 and switched on or off in response to a second control signal con2, an eighth capacitor C8 connected between the other end of the second switch element G2 and the ground, the battery and the indicator 200 connected to the eighth capacitor C8 in parallel and connected to each other in series, and a power managing unit 21. The indicator 200 may be implemented using a light emitting diode. Additionally, a temperature sensor, voltage sensor, current flow sensor, and the like may be included.

The power receiving coil L4, the sixth capacitor C6, and the seventh capacitor C7 may receive the wirelessly transmitted power.

The second switch element G2, the third switch element G3, and the eighth capacitor C8 may convert the power received by the power receiving coil L4, the sixth capacitor C6, and the seventh capacitor C7 into charging power in response to the second control signal con2 and the third control signal con3, and output the charging power.

The power managing unit 21 may output the second control signal con2 and the third control signal con3. For example, the power managing unit 21 may vary and output the second control signal con2 and the third control signal con3 depending on a level of charge of the battery, a temperature thereof, a current flow, a voltage level, combinations thereof or the like. The power managing unit 21 may detect a voltage Vbatt across the battery to detect the level of charge of the battery.

In an example in which the wireless power transmitting system is configured as illustrated in FIG. 10, when the battery is charged, such that the voltage Vbatt across the battery is increased, a current transferred to the battery may be reduced, such that a current flowing through the indicator 200 (for example, a light emitting diode) may be reduced. Therefore, as the battery is charged, a light intensity irradiated through the indicator 200 (for example, the light emitting diode) may be reduced.

The power receiving coil L4, the sixth capacitor C6, the seventh capacitor C7, the third switch element G3, the second switch element G2, the eighth capacitor C8, the indicator 200, the power managing unit 21, and the like, may be disposed in the battery case.

That is, when a level of charge of the battery is small, such that charging for the battery is performed, a light intensity irradiated through the indicator 200 (for example, the light emitting diode) may be large, such that a light intensity incident to the LDR 100 may also become a reference value or more, and the LDR 100 may have a small resistance value. Therefore, the high-level detection signal Vdet may be output. As a result, the control signal generator 12 may output the first control signal con1 so that the wireless power may be transmitted or higher wireless power may be transmitted.

When the battery is charged, such that a level of charge of the battery is increased, a light intensity irradiated through the indicator 200 (for example, the light emitting diode) may be reduced, such that a light intensity incident to the LDR 100 may also become the reference value or less, and the LDR 100 may have a large resistance value. Therefore, the low-level detection signal Vdet may be output. As a result, the control signal generator 12 may output the first control signal con1 so that the wireless power is not transmitted or lower wireless power may be transmitted.

Components of the wireless power receiver 20, particularly, the power receiving coil L4, the sixth capacitor C6, the seventh capacitor C7, the second switch element G2, the third switch element G3, and the eighth capacitor C8 may be variously modified.

In addition, although an example in which the light intensity irradiated through the indicator 200 (for example, the light emitting diode) is large when the level of charge of the battery of the wireless power receiver 20 is small, and is small when the level of charge of the battery of the wireless power receiver 20 is large has been described by way of example in an exemplary embodiment in the present disclosure illustrated in FIG. 10, the light intensity irradiated through the indicator 200 (for example, the light emitting diode) may also be set as opposed to the example described above. That is, the wireless power transmitting system may also be configured so that the light intensity irradiated through the indicator 200 (for example, the light emitting diode) is small when the level of charge of the battery of the wireless power receiver 20 is small, and is large when the level of charge of the battery of the wireless power receiver 20 is large.

In this example, the first voltage output by the first voltage generator 1110 (see FIG. 8) of the detector 11 (see FIG. 8) of the comparator circuit 1130 (see FIG. 8) may be applied to a negative (−) input terminal of the comparator CMP (see FIG. 8), and the second voltage output by the second voltage generator 1120 (see FIG. 8) of the detector 11 (see FIG. 8) may be applied to a positive (+) input terminal of the comparator CMP (see FIG. 8) of the comparator circuit 1130 (see FIG. 8). Alternatively, the control signal generator 12 (see FIG. 7) may output the first control signal con1 so that the power transmitting circuit 13 (see FIG. 7) transmits the power while the detection signal Vdet is in the low level, and output the first control signal con1 so that the power transmitting circuit 13 (see FIG. 7) does not transmit the power while the detection signal Vdet is in the high level.

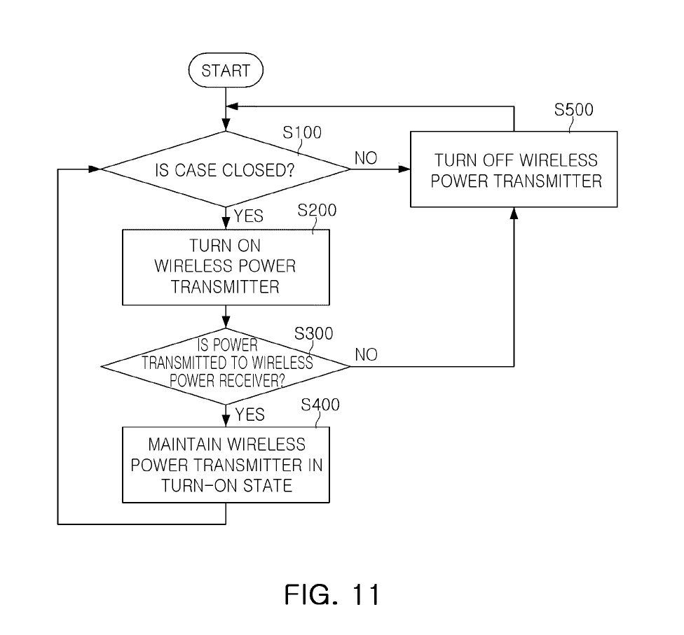

FIG. 11 is a flow chart illustrating a wireless power transmitting method according to an exemplary embodiment in the present disclosure.

First, it may be determined whether or not the case is closed (S100). For example, it may be determined whether the two terminals of the opening and closing detector 110 of FIG. 1 are opened or short-circuited.

When it is determined that the case is closed as a determination result in S100, the power may be wirelessly transmitted (S200). For example, the power Vs may be supplied to the power transmitting circuit 13 and the controller 14 of FIG. 7. In addition, the controller 14 of FIG. 7 may output the first control signal con1 for transmitting the power to the power transmitting circuit 13.

When it is determined that the case is open as the determination result in S100, the power may not be wirelessly transmitted (S500).

Next, it may be determined whether or not the power is transmitted to the wireless power receiver using the light (S300). That is, it may be determined whether or not the battery of the wireless power receiver 2 is sufficiently charged. For example, it may be determined whether or not the power is transmitted to the wireless power receiver by deciding whether or not a light intensity of the indicator 200 is the reference value or more.

When the power is transmitted to the wireless power receiver as a determination result in S300, the power may be wirelessly transmitted continuously (S400).

When it is determined that the case is open as the determination result in S100 or the power is not transmitted to the wireless power receiver as the determination result in S300, the wireless power transmitter may not transmit the power.

In S300, instead of deciding whether or not the power is transmitted, a state of the battery of the wireless power receiver such as a level of charge of the battery of the wireless power receiver, or the like, may be determined. In this case, in S400, a magnitude of the wirelessly transmitted power may be adjusted depending on the determination result in S300.

All or some of S100 to S500 illustrated in FIG. 11 may be performed by the control signal generator 12 of FIG. 7.

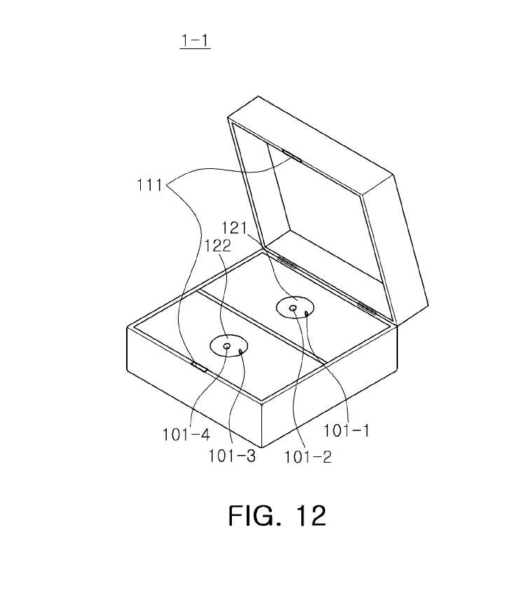

FIG. 12 is a view schematically illustrating an application of the wireless power transmitter according to an exemplary embodiment in the present disclosure. The wireless power transmitter according to an exemplary embodiment in the present disclosure may be mounted in a case 1-1.

The case 1-1 may include one or more internal spaces 121 and 122 in which a device including the wireless power receiver is fixedly disposed. The device including the wireless power receiver may be positioned in a predetermined direction in the internal spaces 121 and 122.

One or more LDRs 101-1, 101-2, 101-3, and 101-4 may be disposed at predetermined positions in each of one or more internal spaces 121 and 122. In detail, the device including the wireless power receiver may include one or more indicators, and the LDRs 101-1, 101-2, 101-3, and 101-4 may be disposed at positions corresponding to the indicators in a case in which the device including the wireless power receiver is disposed in each of the internal spaces 121 and 122.

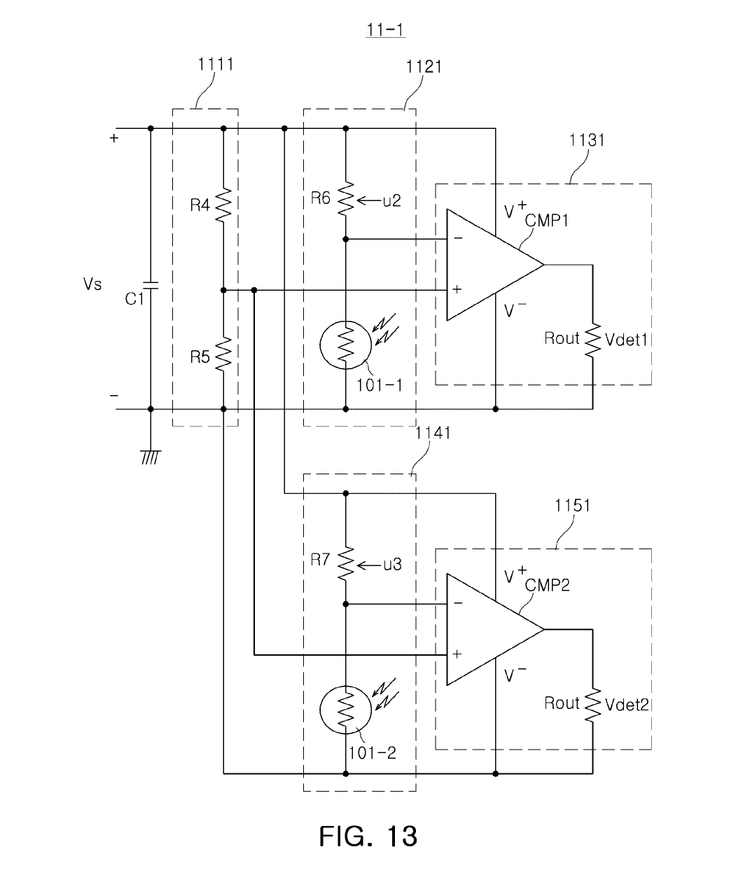

FIG. 13 is a view schematically illustrating an example of a detector of a controller that may be used in the application of the wireless power transmitter according to an exemplary embodiment illustrated in FIG. 12. The detector 11-1 includes a first voltage generator 1111, a second voltage generator 1121, a first comparator circuit 1131, a third voltage generator 1141, and a second comparator circuit 1151.

An operation of the detector 11-1 may be understood through the description of FIG. 8 and will not be repeated here to maintain conciseness, clarity, and brevity.

In the wireless power transmitter according to an exemplary embodiment, the detector 11-1 of FIG. 13 may be provided in each of the internal spaces 121 and 122 of the case 1-1 of FIG. 12.

In a case in which the detector has a configuration as illustrated in FIG. 13, the control signal generator 12 (see FIG. 7) may output the first control signal con1 depending on the detection signals det1 and det2. For example, the control signal generator 12 (see FIG. 7) may output the first control signal con1 so that the power transmitting circuit 13 (see FIG. 7) transmits power having a relatively large magnitude in a case in which both of the detection signals det1 and det2 have the high level, output the first control signal con1 so that the power transmitting circuit 13 (see FIG. 7) transmits power having a relatively low magnitude in a case in which one of the detection signals det1 and det2 has the high level and the other of the detection signals det1 and det2 has the low level, and output the first control signal con1 so that the power transmitting circuit 13 (see FIG. 7) does not transmit power in a case in which both of the detection signals det1 and det2 have the low level.

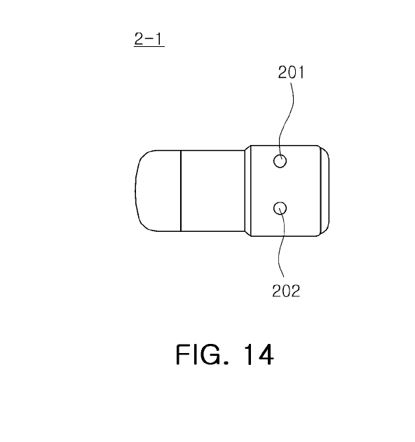

FIG. 14 is a view schematically illustrating an example of a device including the wireless power receiver according to an exemplary embodiment in the present disclosure.

The device 2-1 including the wireless power transmitter may include a plurality of indicators 201 and 202. Light irradiated by the plurality of indicators 201 and 202 may be changed depending on a state of a battery of the device 2-1 including the wireless power transmitter. For example, all of the plurality of indicators 201 and 202 may irradiate light of which an intensity is equal to a reference value or more in a case in which a level of charge of the battery is lower than a first reference value, only one of the plurality of indicators 201 and 202 may irradiate light of which an intensity is the reference value or more in a case in which the level of charge of the battery is between the first reference value and a second reference value higher than the first reference value, and all of the plurality of indicators 201 and 202 may irradiate light of which an intensity is the reference value or less in a case in which the level of charge of the battery is higher than the second reference value.

Although a case in which the device including the wireless power receiver according to the present disclosure is the hearing aid has been described by way of example hereinabove, the wireless power receiver according to the present disclosure may be mounted in various wearable devices such as smartglasses, and the like.

In addition, the case of the wireless power transmitter may have an appropriate form depending on the device including the wireless power receiver.

The apparatuses, units, modules, devices, and other components (e.g., controller 14, power supply 15, detector 11, control signal generator 12, sensor 16, voltage generator 1110, comparator circuit 1130, indicator 200, LDRs 100-1) illustrated in FIGS. 2 and 4 that perform the operations described herein with respect to FIGS. 1-3, 6-10, and 13-14 are implemented by hardware components. Examples of hardware components include controllers, sensors, generators, drivers, and any other electronic components known to one of ordinary skill in the art.

In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result.

In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 7-11.

The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 7-11 that perform the operations described herein may be performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above.

In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media.

Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

As a non-exhaustive example only, a wireless receiver device for charging may include a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, or any other mobile or stationary device capable of wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

As set forth above, according to an exemplary embodiment in the present disclosure, the wireless power transmitter may determine information related to a state of the wireless power receiver, for example, a level of charge of the battery, and the like, through the exemplary configurations. The wireless power receiver according to an exemplary embodiment in the present disclosure may be applied particularly to a small wireless power receiver such as a hearing aid, or the like.

What is claimed is:

1. A wireless power transmitter comprising:
a controller configured to output a control signal in response to detected light; and,
a power transmitting circuit configured to wirelessly radiate power in response to the control signal.

2. The wireless power transmitter of claim 1, further comprising a case providing an internal space accommodating the wireless power receiver therein and having the controller and the power transmitting circuit mounted thereon.

3. The wireless power transmitter of claim 2, wherein the power transmitting circuit is configured to wirelessly supply the power when the case is closed and blocks supply of the power when the case is open.

4. The wireless power transmitter of claim 2, further comprising an opening and closing detector comprising at least one terminal opened or short-circuited depending on whether the case is respectively open or closed.

5. The wireless power transmitter of claim 4, wherein the controller is configured to output the control signal depending on states of the at least one terminal of the opening and closing detector.

6. The wireless power transmitter of claim 2, further comprising a sensor configured to output a sensing signal depending on whether the case is open or closed.

7. The wireless power transmitter of claim 6, wherein the controller is configured to output the control signal in response to detected light, the sensing signal, or combinations thereof.

8. The wireless power transmitter of claim 1, wherein the controller comprises:
a detector configured to output a detection signal depending on an intensity of received light; and
a control signal generator configured to output the control signal in response to the detection signal.

9. The wireless power transmitter of claim 8, wherein the detector comprises:
a first voltage generator configured to receive power and to responsively output a first voltage;
a second voltage generator configured to receive the power and to responsively output a second voltage varied depending on the intensity of received light; and
a comparator circuit configured to compare the first voltage and the second voltage with each other and responsive to the comparison, to output the detection signal.

10. The wireless power transmitter of claim 9, wherein the second voltage generator comprises:
a resistor connected to a terminal to which the power is input; and
a light detecting resistor (LDR) connected between the resistor and a ground and configured to establish a resistance value varied depending on the intensity of received light.

11. The wireless power transmitter of claim 10, wherein the resistor is a variable resistor configured to have a resistance value varied in response to an adjustment signal input from an external source.

12. The wireless power transmitter of claim 1, further comprising a power supply configured to supply the power to the controller and the power transmitting circuit.

13. A wireless power receiver apparatus comprising:
a power receiver configured to receive wirelessly transmitted power and output charging power for charging a battery;
a power managing circuit configured to control the power receiver depending on a level of charge of the battery; and
an indicator configured to emit light depending on a determined status of the battery.

14. The wireless power receiver of claim 13, wherein the power receiver comprises:
a receiver configured to receive the wirelessly transmitted power using a receiving coil; and
a converter configured to convert the power received by the receiver into the charging power in response to a control signal output by the power managing circuit.

15. The wireless power receiver of claim 14, wherein the indicator includes a light emitting diode connected between the battery and the converting unit.

16. A wireless power transmission method comprising:
actuating a power supply to radiate a wireless power from a resonator;
continuously determining a luminance characteristic; and,
adaptively controlling the power supply to change the wireless power radiation responsive to detected changes in the luminance characteristic.

17. The wireless power transmission method of claim 16, wherein the power supply is actuated responsive to a determination that a wireless power receiving apparatus has been enclosed within a wireless power transmission apparatus.

18. The wireless power transmission method of claim 16, wherein the power supply is actuated responsive to a determination that a locking mechanism has been actuated to lock a wireless receiving apparatus within a wireless transmission apparatus.

19. The wireless power transmission method of claim 16, wherein the power supply is adaptively controlled to change a magnitude of the wireless power transmission according to a determined luminance characteristic of a wireless power receiving apparatus.

20. A method of controlling wireless power charging, comprising:
determining an operational characteristic in a wireless power receiver;
selectively actuating a light emitting device within the wireless power receiver to emit a light indicating a requested magnitude of wireless power radiation according to the determined operational characteristic; and,
responsive to reception of a wireless power radiation, actuating a power management circuit to supply current to a battery within the wireless power receiver.

21. The method of controlling wireless power charging of claim 20, wherein the light emitting device is selectively actuated to emit a light pattern encoding a requested magnitude of wireless power radiation from a wireless power transmitter according to the determined operational characteristic in the wireless power receiver.

22. The method of controlling wireless power charging of claim 20, wherein the operational characteristic includes at least one of: voltage across the battery, current flow, temperature, or time, or combinations thereof.

23. The method of controlling wireless power charging of claim 21, wherein the light emitting device is selectively actuated at a luminance intensity corresponding to a requested magnitude of wireless power radiation from the wireless power transmitter according to the determined operational characteristic in the wireless power receiver.
